(19) United States
(12) Patent Application Publication
(10) Pub. No.: US 2002/0090848 A1
(43) Pub. Date: Jul. 11, 2002

(54) Folding plug

(76) Inventor: Wen-Chung Yu, Shin-Jung city (TW)

Correspondence Address: BACON & THOMAS, 4th Floor, 625 Slaters Lane, Alexandria, VA, 22314, US

(21) Appl. No.: 09/756,770

(22) Filed: Jan. 10, 2001

(51) Int. Cl. H01R 13/44

(52) U.S. Cl. 439/131

(57) ABSTRACT

The present invention relates to a folding plug which has two bottom slots at center of a base while the bottom slots are extended outward with two receiving slots disposed in parallel. Two shaft supports are interposed in parallel between the bottom slots, and the middle section of the shaft supports is fitted with a dished member. Besides, a locating recess is laterally interposed between the shaft supports. When a cover with a press bar is covered on the base, the dished member of the shaft supports is placed upon the shaft used to connect the prongs. The shaft is clamped between the shaft supports of the base and the press bar of the cover so that the prongs are swiveled between the bottom slots and the receiving slots at different angles. In addition, at least two locating flanges are mounted on the rim of said shaft, and the engagement state of the locating flanges of the shaft with the locating recess is changeable so that the prongs can be located at all prearranged angles for different applications.

### BACKGROUND OF THE INVENTION

1. Field of the Invention

The present invention relates to a folding plug, and more particularly, to a plug whose prongs can be freely bent within prearranged angles and located at certain angles for different applications.

2. Description of the Prior Art

A conventional plug, like the swivel plug 4, as shown in FIG. 1, includes a swivel head 41 at one side thereof which has two prongs 42 at outer side thereof. The prongs 42 are joined to a conductive piece 43 by means of a swivel member 421, thereafter extending to insertion slots 44. By means of the swivel head, the swivel plug 4 can be used for inserting at all angles. However, the aforementioned swivel plug has its drawbacks. The swivel member 421 for joining the swivel plug 4 to the swivel head 41 is riveted for pivoting the swivel head 41. Besides, it plays an important part in attaching the prongs 42 to the conductive piece 43. It is easy to be worn out after use for a long period, thereby causing a loosened state between the swivel plug 4 and the swivel head 41. As a result, a bad contact between the prongs 42 and the conductive piece 43 is created. Moreover, no locating members are disposed between the swivel head 41 and the swivel plug 4 so that the swivel head 41 is freely swiveled to all desired angles and positions. However, the angle or the position thereof is easily changed by the weight of the plug inserted in slots 44.

### SUMMARY OF THE INVENTION

It is a primary object of the present invention to eliminate the aforementioned drawbacks and to provide a folding plug which has two bottom slots at center of a base while the bottom slots are extended outward with two receiving slots disposed in parallel. Two shaft supports are interposed in parallel between the bottom slots, and the middle section of the shaft supports is fitted with a dished member for receiving the shaft used to connect the prongs. When the base is covered with a cover, the press bar with dished member is placed upon the shaft, and the shaft is clamped between the shaft supports of the base and the press bar of the cover so that the prongs are swiveled between the bottom slots and the receiving slots at different angles for various applications.

It is another object of the present invention to provide a folding plug in which a locating recess is laterally disposed between two shaft supports, and the shaft has a plurality of locating flanges at the rim thereof. In swiveling the prongs, the engagement state of the locating flanges of the shaft with the locating recess is changeable so that the prongs can be located at all prearranged angles for different applications.

### BRIEF DESCRIPTION OF TILE DRAWINGS

The drawings disclose illustrative an embodiment of the present invention which serves to exemplify the various advantages and objects hereof, and are as follows:

FIG. 1 is a perspective assembly view of a conventional swivel plug;

FIG. 2 is a perspective exploded view of the present invention;

FIG. 3 is a schematic drawing of the present invention showing the prongs fully extend;

FIG. 4 is a schematic drawing of the present invention showing the prongs are inclined; and

FIG. 5 is a schematic drawing of the present invention showing the prongs are folded.

### DETAILED DESCRIPTION OF THE PREFERRED EMBODIMENT

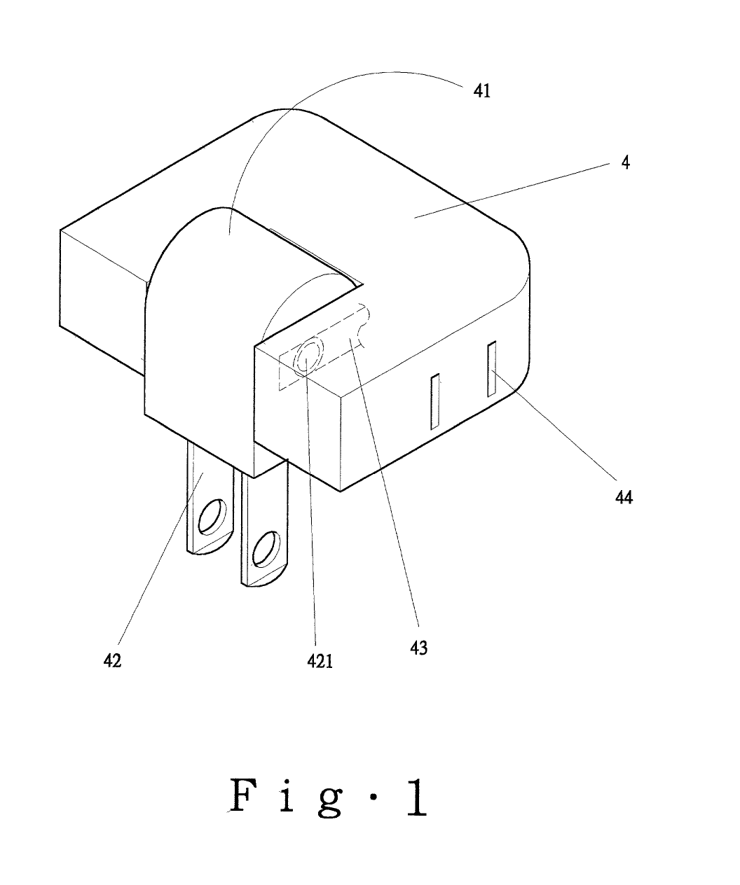

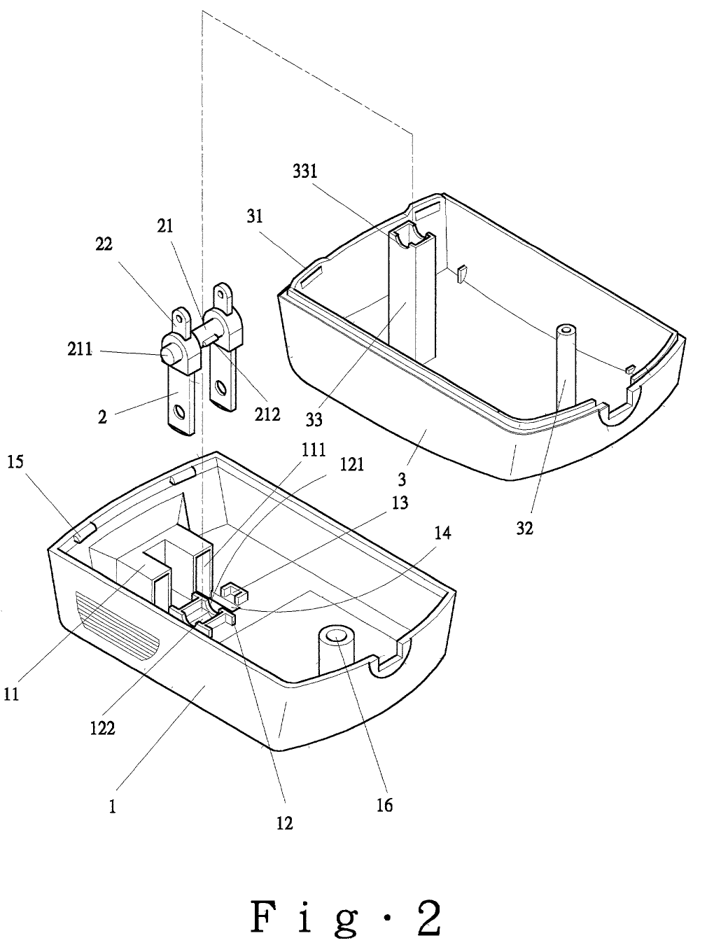

FIG. 1 shows a perspective assembly view of a conventional swivel plug. The configuration and the disadvantage thereof have been shown above and won't be described more hereinafter. Referring to FIG. 2, the folding plug in accordance with the present invention at least includes a base 1, two prongs 2 and a cover 3. The base 1 is constructed as a housing with an opening at one side thereof. The opening side of the base 1 contains two engaging flanges 15 at inner rim thereof while the opposite side thereof is fitted with an upward extending attachment sleeve 16. A prong accommodation 11 is mounted near the opening side of the base 1, and two receiving slots 11 parallel connected to the outside are disposed inside the prong accommodation 11 while two bottom slots 14 are provided in connection with the receiving slots 111. A U-shaped clamping seat 13 is respectively arranged at the outer side of the bottom slots 14 while two shaft supports 12 are interposed in parallel between the bottom slots 14. The shaft supports 12, respectively, have a dished member 121 at center thereof while a locating recess 122 is laterally mounted between the shaft supports 12. The two prongs 2 are joined by a shaft 21 which is extended with a support projection 211 at two ends thereof, respectively. At least two locating flanges 212 are well-distributed on the rim of the shaft 21. Moreover, the prongs 2, respectively, includes a lead joint 22 at one end thereof, and the lead is received inside the base 1. The cover 3 is also constructed as a housing with opening. Two locking seats 31 are disposed at the positions opposite to the engaging flanges 15 of the base 1. Besides, the cover 3 includes a locating pole 32 and a press bar 33 at two sides thereof both of which correspond to the attachment sleeve 16 and the shaft supports 12 of the base 1. The press bar 33 has a dished member 331 symmetric to the locating recess 122.

In assembly, the prongs 2 are placed into the bottom slots 14 such that the shaft 21 leans against the dished member 121 of the shaft supports 12 while the support projections 211 are received in the clamping seats 13. Thereafter, the press bar 33 of the cover 3 is placed on the shaft 21, thereby engaging the engaging flanges 15 into the locking seats 31 of the cover 3 while the locating pole 32 is inserted into the attachment sleeve 16. At last, the base 1 and the cover 3 are screwed together.

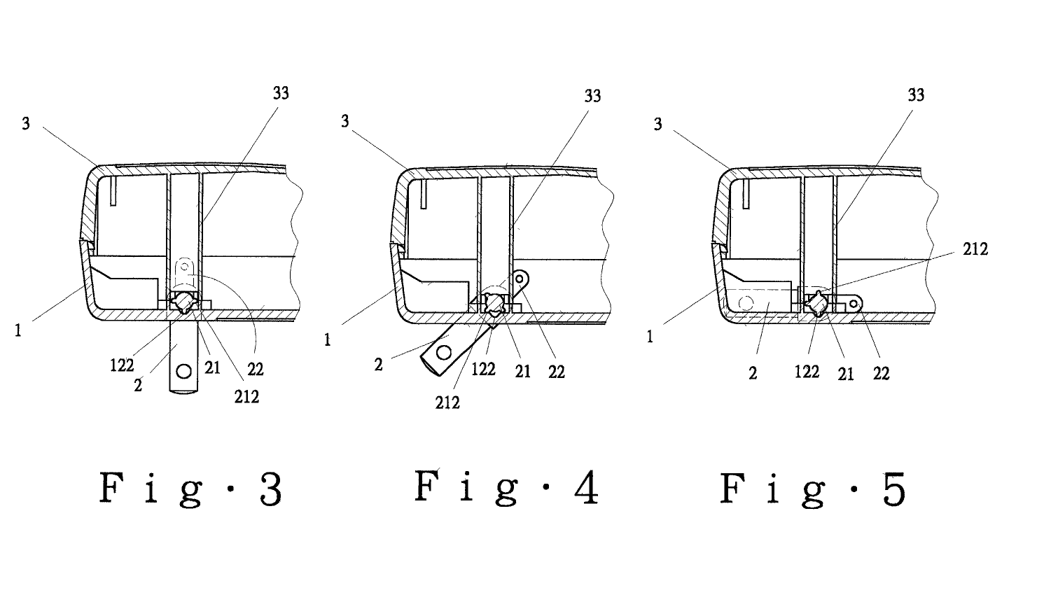

Referring to FIGS. 3 through 5, they show the different bending angles of the prongs of the present invention. The shaft 21 is clamped between the shaft supports 12 of the base 1 and the press bar 33 of the cover 3 so that the prongs 2 are swiveled on the shaft 21. Besides, the prongs 2 are located at different angles by means that the locating flanges 212 are engaged in different positions of the locating recess 122. If the shaft 21 is swiveled until the locating flanges 212 are locked at two sides of the locating recess 122, the prongs 2 are bent in an inclined state (see FIG. 4). If the prongs 2 are swiveled to the lateral position, they can then be folded in the receiving slots 111 of the prong accommodation 11 (see FIG. 5) for storage.

Many changes and modifications in the above-described embodiment of the invention can, of course, be carried out without departing from the scope thereof Accordingly, to promote the progress in science and the useful arts, the invention is disclosed and is intended to be limited only by the scope of the appended claims.

What is claimed is:

1. A folding plug at least comprising:
a base in shape of a housing with an opening at one side thereof having a prong accommodation mounted near the opening side of said base, two receiving slots parallel connected to the outside being disposed inside said prong accommodation while two bottom slots are provided in connection with said receiving slots, two shaft supports interposed in parallel between said bottom slots while said shaft supports, respectively, have a dished member at center thereof, a locating recess being laterally mounted between said shaft supports;
two prongs joined by a shaft and having at least two locating flanges being well-distributed on the rim of said shaft, a lead joint being disposed at one end thereof so that the lead is received inside said base;
a cover in shape of a housing with opening having a press bar at one side thereof which corresponds to said shaft supports of said base, said press bar having a dished member symmetric to said locating recess;
wherein, in assembly, said prongs are placed into the bottom slots such that said shaft leans against said dished member of said shaft supports while said support projections are received in said clamping seats, whereupon said press bar of said cover is placed on said shaft so that said prongs are located at different angles by means that said locating flanges are engaged in different positions of said locating recess.

2. A folding plug as claimed in claim 1, wherein the opening side of said base includes two engaging flanges at inner rim thereof while two locking seats are disposed at the positions opposite to said engaging flanges for engagement with each other.

3. A folding plug as claimed in claim 1, wherein the bottom side of said base is fitted with an upward extending attachment sleeve, and wherein a locating pole of said cover is engaged into said attachment sleeve, whereupon both of them are screwed together.

4. A folding plug as claimed in claim 1, wherein a U-shaped clamping seat is respectively arranged at the outer side of said bottom slots of said base, and wherein two ends of said shaft are respectively extended with support projections which are placed inside said clamping seats in position.
